(19) United States
(12) Patent Application Publication
(10) Pub. No.: US 2026/0131386 A1
(43) Pub. Date: May 14, 2026

(54) Replaceable Tip System for Cutting Devices

(71) Applicants: Michael Klabenes, O'Neill, NE (US); Melvin Zehr, O'Neill, NE (US)

(72) Inventors: Michael Klabenes, O'Neill, NE (US); Melvin Zehr, O'Neill, NE (US)

(21) Appl. No.: 18/946,081

(22) Filed: Nov. 13, 2024

(51) Int. Cl. B23B 27/16

(52) U.S. Cl. CPC B23B 27/16; B23B 2260/146

(57) ABSTRACT

A replaceable tip system for cutting devices includes a cutting element, an adapter, a base, and a wedge. The cutting element includes a tip and a shaft extending from the tip. The adapter includes a channel extending through the adapter. The base is coupled to a driven cutting piece. The wedge extends from the base. The wedge is insertable into the channel to urge the shaft into frictional engagement with the adapter and thereby secure the cutting element to the adapter to prevent disengagement of the cutting element from the adapter and the base. The cutting element, the adapter, and the wedge are designed and positioned such that forces generated during a cutting operation on the cutting element bias the cutting element and the adapter toward the wedge and thereby enhance the frictional engagement.

### (b) CROSS-REFERENCE TO RELATED APPLICATIONS

Not Applicable

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to industrial rotary cutting tools and more particularly pertains to a new replaceable tip system for detachably connecting replaceable cutting elements, such as cutting inserts or cutting teeth, without the use of a tool and a connecting structure, such as a screw or bolt, passing through the cutting element itself. Such a cutting element is structurally very solid and easily manufactured and replaced. The replaceable tip system uses an adapter and a wedge that can be inserted into the adapter. The wedge urges a shaft of the cutting element into frictional engagement with the adapter. During a cutting operation, forces on the cutting element bias the cutting element and the adapter toward the wedge and thereby enhance the frictional engagement, such that the frictional forces hold the shaft between the adapter and the wedge and prevent removal of the cutting element without the need for a screw or bolt or similar passing through or otherwise securing or holding the cutting element in place.

(2) Description of Related Art including information disclosed under 37 CFR 1.97 and 1.98.

The prior art relates to industrial rotary cutting tools. The prior art, as best understood, discloses cutting teeth that are connected or mounted using screws or bolts passing through the cutting teeth themselves. Other designs mount the cutting teeth without screws or bolts but utilize customized connecting pieces. The prior art does not disclose a replaceable tip system for cutting devices that includes a cutting element, an adapter, a base, and a wedge. The cutting element includes a tip and a shaft extending from the tip, and the adapter includes a channel extending through the adapter. The cutting element, the adapter, and the wedge are designed and positioned such that forces generated during a cutting operation on the cutting element bias the cutting element and the adapter toward the wedge and thereby enhance the frictional engagement.

### (h) BRIEF SUMMARY OF THE INVENTION

An embodiment of the disclosure meets the needs presented above in a replaceable tip system generally comprising a cutting element, an adapter, a base, and a wedge. The cutting element includes a tip and a shaft extending from the tip. The adapter includes a channel extending through the adapter. The base is coupled to a driven cutting piece. The wedge extends from the base. The wedge is insertable into the channel to urge the shaft into frictional engagement with the adapter and thereby secure the cutting element to the adapter to prevent disengagement of the cutting element from the adapter and the base. The cutting element, the adapter, and the wedge are designed and positioned such that forces generated during a cutting operation on the cutting element bias the cutting element and the adapter toward the wedge and thereby enhance the frictional engagement.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an replaceable tip system according to an embodiment of the disclosure.

FIG. 2 is a front view of an embodiment of the disclosure.

FIG. 3 is a side view of an embodiment of the disclosure.

FIG. 4 is a back view of an embodiment of the disclosure.

FIG. 5 is an end view of an adapter of an embodiment of the disclosure.

FIG. 6 is a perspective view of an embodiment of the disclosure assembled.

FIG. 7 is a side cross-sectional view of an embodiment of the disclosure assembled.

FIG. 8 is a box diagram showing an arrangement of components of an embodiment of the disclosure.

### (j) DETAILED DESCRIPTION OF THE INVENTION

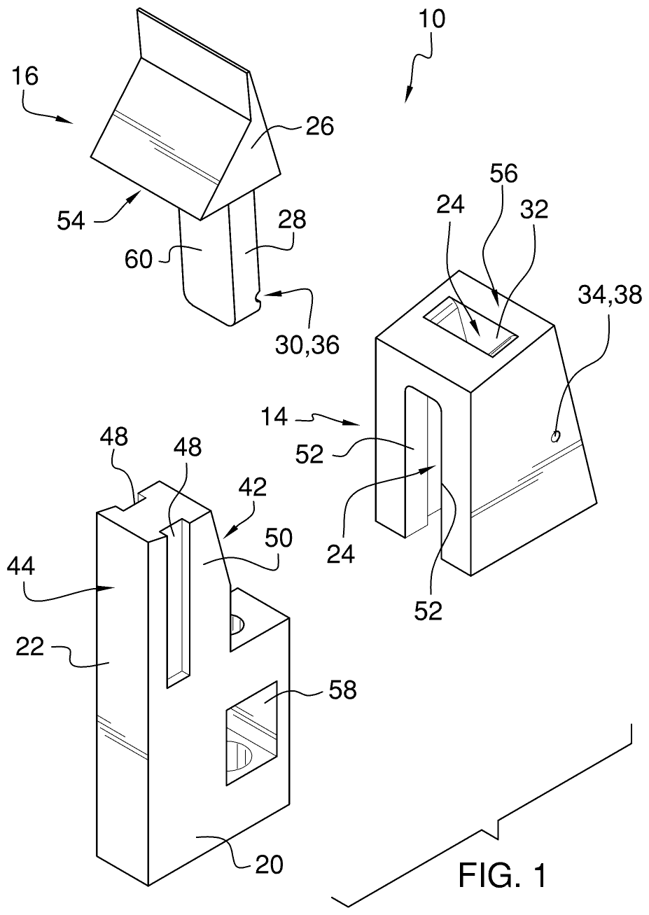

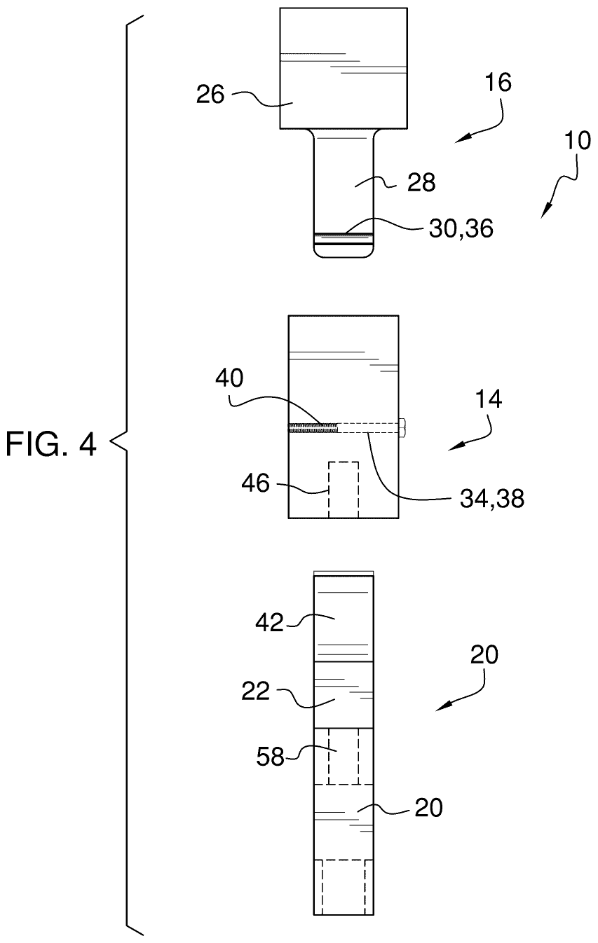

With reference now to the drawings, and in particular to FIGS. 1 through 8 thereof, a new replaceable tip system embodying the principles and concepts of an embodiment of the disclosure and generally designated by the reference numeral 10 will be described.

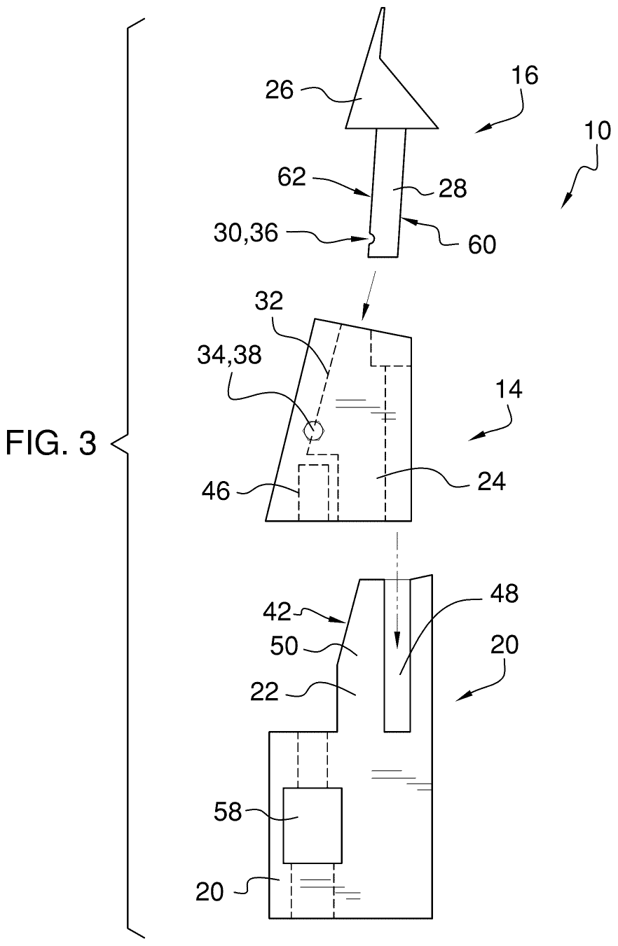

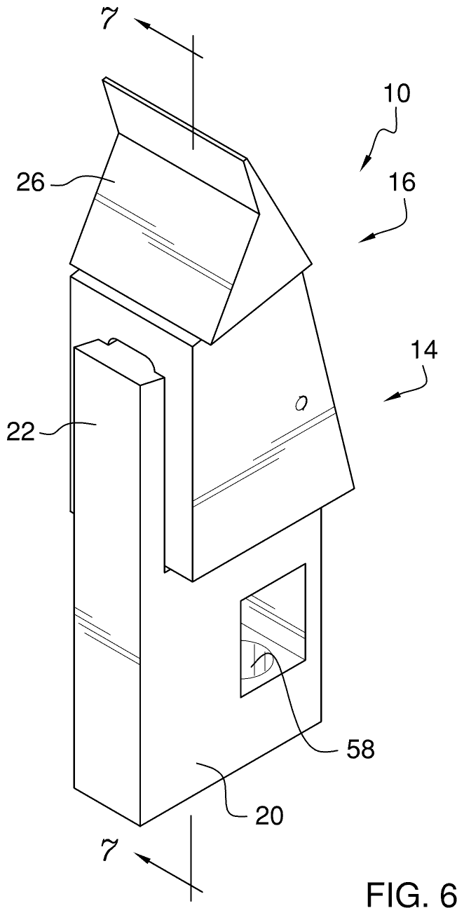

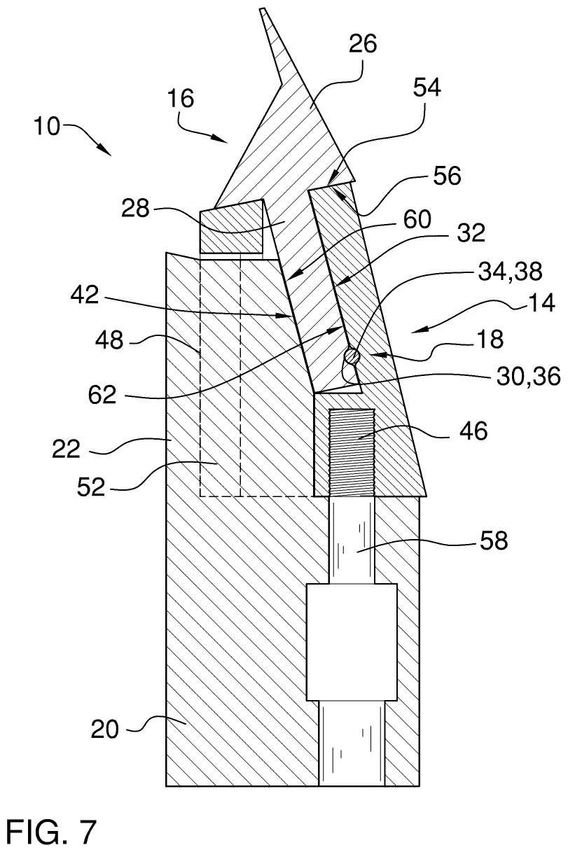

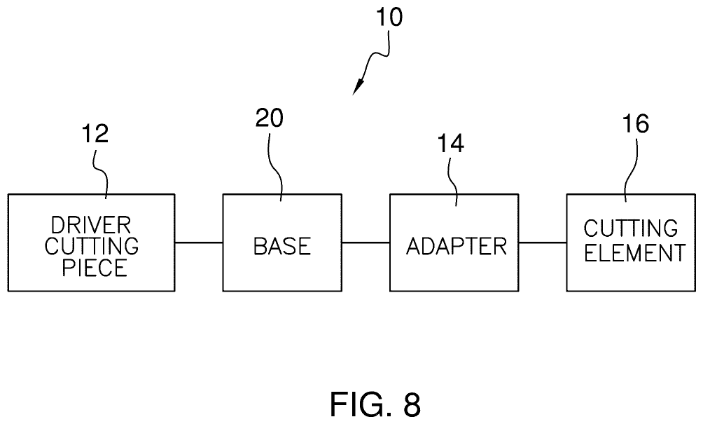

As best illustrated in FIGS. 1 through 8, the replaceable tip system 10 generally comprises a cutting element 16, an adapter 14, a base 20, and a wedge 22. FIGS. 1 through 4 show the base 20, the adapter 14, and the cutting element 16 separated prior to assembly, whereas FIGS. 6 and 7 show all components in an assembled state. With reference to FIG. 1, the cutting element 16 includes a tip 26 and a shaft 28 extending from the tip 26. The adapter 14 includes a channel 24 extending through the adapter 14, as shown in FIG. 1 and in cross-section in FIG. 3. The base 20 is coupled to a driven cutting piece 12, shown schematically in FIG. 8. The wedge 22 extends from the base 20. As best shown in FIGS. 3 and 7, the wedge 22 is insertable into the channel 24 to urge the shaft 28 into frictional engagement with the adapter 14 and thereby secure the cutting element 16 to the adapter 14 to prevent disengagement of the cutting element 16 from the adapter 14 and the base 20. The cutting element 16, the adapter 14, and the wedge 22 are designed and positioned such that forces generated during a cutting operation on the cutting element 16 bias the cutting element 16 and the adapter 14 toward the wedge 22 and thereby enhance the frictional engagement.

In the exemplary embodiment shown in the figures, the cutting element 16 is secured to the adapter 14 without a fastener inserted into or through an opening in the cutting element 16. As best seen in FIG. 3, the wedge 22 includes a contact surface 42. The wedge 22 also has a non-contact surface 44 facing away from the wedge 22 and extending along the length of the wedge 22 and the base 20. The channel 24 includes an interior surface 32 positioned to face the contact surface 42 when the wedge 22 is inserted in the adapter 14. The shaft 28 includes a first outer surface 60 and a second outer surface 62 positioned opposite the first outer surface 60. As shown in FIG. 7, the first outer surface 60 is in frictional engagement with the contact surface 42 of the wedge 22 and the second outer surface 62 is in frictional engagement with the interior surface 32 of the channel 24 when the wedge 22 is inserted in the adapter 14 with the shaft 28 there between.

In the exemplary embodiment shown, the contact surface 42 of the wedge 22 is inclined to urge the shaft 28 into frictional engagement with the adapter 14 when the wedge 22 is inserted into the channel 24. The interior surface 32 is inclined to be essentially parallel to the contact surface 42 when the wedge 22 is inserted in the channel 24.

In the exemplary embodiment shown, the replaceable tip system 10 further includes a coupler 18. The coupler 18 includes a first connecting element 30 and a second connecting element 34. The first connecting element 30 is positioned at the interior surface 32 of the channel 24. The second connecting element 34 is positioned at the second outer surface 62 of the shaft 28, wherein the second connecting element 34 is designed to engage with the first connecting element 30 in a form fit to supplement the frictional engagement and further secure the cutting element 16 against removal from between the adapter 14 and the wedge 22.

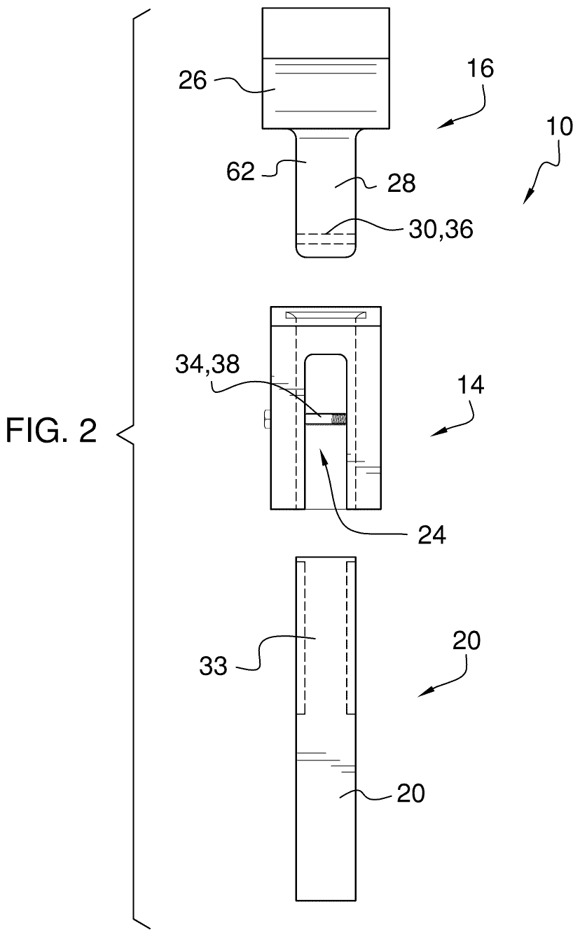

In one possible embodiment, the second connecting element 34 is in the form of a recess 36 in the shaft 28 and the first connecting element 30 projects beyond the interior surface 32 of the channel 24 and into the recess 36. In the exemplary embodiment shown in FIG. 2, the first connecting element 30 is an elongated element 38 removably positioned in the adapter 14 transverse to the channel 24 and designed to engage the recess 36 to further prevent axial movement of the shaft 28 out of the channel 24. In the exemplary embodiment shown in FIG. 2, the elongated element 38 is a pin, in this case a threaded bolt or screw that has a threaded connection 40 with the adapter 14, though in one possible embodiment the pin could be smooth and without threads. The elongated element 38 is essentially cylindrical, though other shapes such as square or rectangular, or even a dovetail design, are within the scope of the disclosure.

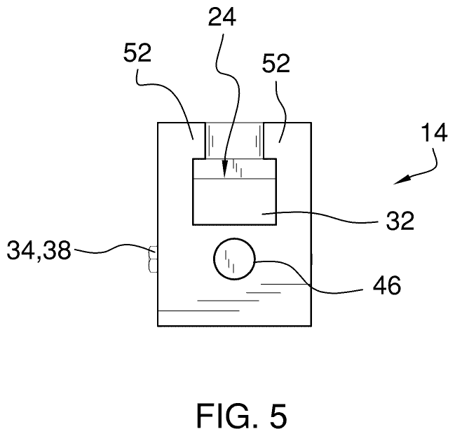

As shown in FIG. 1, the wedge 22 includes a side surface 50 transverse to the contact surface 42. The wedge 22 also includes a slot 48 positioned in the side surface 50. As shown in FIG. 5, the adapter 14 includes a projection 52 projecting inwardly into the channel 24, wherein the projection 52 is removably insertable into the slot 48 to guide and further hold the wedge 22 and the adapter 14 together and thereby further enhance the frictional engagement between the shaft 28 and the adapter 14. In the exemplary embodiment shown, the wedge 22 includes a pair of the side surfaces 50 and a pair of the slots 48, one in each of the side surfaces 50. The adapter 14 includes a pair of the projections 52 positioned on opposite sides of the channel 24 and facing one another.

The tip 26 includes a first end face 54 positioned about the shaft 28. The adapter 14 includes a second end face 56 positioned about an end of the channel 24. As shown in FIG. 7, the first end face 54 abuts the second end face 56 when the shaft 28 is inserted into the adapter 14. Other designs of the interface between the tip 26 and the adapter 14, such as contoured surfaces or complementary projections and grooves, are within the scope of the disclosure. In the exemplary embodiment shown, the adapter 14 includes a receptacle designed to receive a connecting structure to further detachably connect the adapter 14 to the base 20 and further bias the adapter 14 toward the wedge 22 to enhance the frictional engagement between the adapter 14 and the shaft 28. For example, the receptacle could be threaded to engage with a bolt or a screw passing through a passage 58 in the base 20.

FIG. 8 shows that the base 20 is connected to the driven cutting piece 12, which can be a rotary wheel, cylinder, or disc. The base 20 can be detachably connected to the driven cutting piece 12, or the base 20 can be integrally formed as part of the driven cutting piece 12. The driven cutting piece 12 could be part of an industrial rotary cutting tool, such as a grinder or cutter for use in machining, chipping, or crushing.

In use, the replaceable tip system 10 allows a user to replace the cutting element 16 when the tip 26 becomes worn or damaged. The cutting elements 16 can be made of standard cutting materials, such as steel, carbide, ceramic, or variations or combinations thereof. To initially assemble the replaceable tip system 10, the shaft 28 is inserted into the channel 24 in the adapter 14. At this point the shaft 28 is movable or pivotable in the channel 24, which is larger than the shaft 28. The shaft 28 is oriented such that the recess 36 is facing the elongated element 38. The adapter 14 and the base 12 can be brought together using the slots 48 and the projections 52 as a guide, such that the wedge 22 is at least partially inside the channel 24. As the adapter 14 and base 12 are brought together, the contact surface 42 engages the shaft 28 and the wedge 22 wedges and presses the shaft 28 against the interior surface 32 of the adapter 14. This causes the recess 36 and elongated element 38 to engage one another in a form fit. In the exemplary embodiment shown in FIG. 7, the elongated element 38 located in the base 12 is threaded and screwed into the adapter 14, which brings the adapter 14 and the base 12 together and promotes a tight and secure connection between them, as well as promotes the wedging of the shaft 28 between the contact surface 42 and the interior surface 32 via the wedge action of the wedge 22. Once the tip 26 becomes worn or damaged, the user can remove the tip 26 by essentially reversing the process. The user could completely disassemble the components and then re-assembly with a new cutting element 16. The user could also possibly just loosen the connection between the adapter 14 and the base 12, then remove the elongated element 38 from the adapter 14, and then slide the shaft 28 of the cutting element 16 out from between the wedge 22 of the base 12 and the interior surface 32 of the adapter 14. The shaft 28 of a new cutting element 16 could then be inserted, the elongated element 38 re-inserted, and finally the threaded connection 40 tightened to bring all of adapter 14 and the base 12 into a tight connection again with the new shaft 28 held between the wedge 22 and the interior surface 32 of the adapter 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A replaceable tip system for cutting devices comprising:
a cutting element comprising a tip and a shaft extending from said tip;
an adapter comprising a channel extending through said adapter;
a base coupled to a driven cutting piece;
a wedge extending from said base, said wedge being insertable into said channel to urge said shaft into frictional engagement with said adapter and thereby secure said cutting element to said adapter to prevent disengagement of said cutting element from said adapter and said base, and wherein said cutting element, said adapter, and said wedge are configured and disposed such that forces generated during a cutting operation on said cutting element bias said cutting element and said adapter toward said wedge and thereby enhance the frictional engagement.

2. The replaceable tip system of claim 1, wherein said cutting element is secured to said adapter without a fastener inserted into or through an opening in said cutting element.

3. The replaceable tip system of claim 1, wherein:
said wedge comprises a contact surface;
said channel comprises an interior surface disposed to face said contact surface
when said wedge is inserted in said adapter;
said shaft comprises a first outer surface and a second outer surface disposed opposite said first outer surface; and
said first outer surface is in frictional engagement with said contact surface of said wedge and said second outer surface is in frictional engagement with said interior surface of said channel when said wedge is inserted in said adapter with said shaft there between.

4. The replaceable tip system of claim 3, wherein:
said contact surface of said wedge is inclined to urge said shaft into frictional engagement with said adapter when said wedge is inserted into said channel; and
said interior surface is inclined to be essentially parallel to said contact surface when said wedge is inserted in said channel.

5. The replaceable tip system of claim 3, wherein the replaceable tip system further comprises a coupler, wherein said coupler comprises:
a first connecting element disposed at said interior surface of said channel; and
a second connecting element disposed at said second outer surface of said shaft, wherein said second connecting element is configured to engage with said first connecting element in a form fit to supplement the frictional engagement and further secure said cutting element against removal from between said adapter and said wedge.

6. The replaceable tip system of claim 5, wherein said second connecting element comprises a recess in said shaft and said first connecting element projects beyond said interior surface of said channel and into said recess.

7. The replaceable tip system of claim 6, wherein said first connecting element comprises an elongated element removably disposed in said adapter transverse to said channel and configured to engage said recess to further prevent axial movement of said shaft out of said channel.

8. The replaceable tip system of claim 7, wherein said elongated element comprises a pin.

9. The replaceable tip system of claim 3, wherein:
said wedge comprises a side surface transverse to said contact surface;
said wedge comprises a slot disposed in said side surface; and
said adapter comprises a projection projecting inwardly into said channel, wherein said projection is removably insertable into said slot to guide and further hold said wedge and said adapter together and thereby further enhance the frictional engagement between said shaft and said adapter.

10. The replaceable tip system of claim 9, wherein:
said wedge comprises a pair of said side surfaces and a pair of said slots, one in each of said side surfaces; and
said adapter comprises a pair of said projections disposed on opposite sides of said channel and facing one another.

11. The replaceable tip system of claim 1, wherein:
said tip comprises a first end face disposed about said shaft;
said adapter comprises a second end face disposed about an end of said channel;
and
said first end face abuts said second end face when said shaft is inserted into said adapter.

12. The replaceable tip system of claim 1, wherein said adapter comprises a receptacle configured to receive a connecting structure to further detachably connect said adapter to said base and further bias said adapter toward said wedge to enhance the frictional engagement between said adapter and said shaft.

13. The replaceable tip system of claim 1, wherein:
said cutting element is secured to said adapter without a fastener inserted into or through an opening in said cutting element;
said wedge comprises a contact surface;
said channel comprises an interior surface disposed to face said contact surface when said wedge is inserted in said adapter;
said shaft comprises a first outer surface and a second outer surface disposed opposite said first outer surface;
said first outer surface is in frictional engagement with said contact surface of said wedge and said second outer surface is in frictional engagement with said interior surface of said channel when said wedge is inserted in said adapter with said shaft there between;
said contact surface of said wedge is inclined to urge said shaft into frictional engagement with said adapter when said wedge is inserted into said channel; and
said interior surface is inclined to be essentially parallel to said contact surface when said wedge is inserted in said channel.

14. The replaceable tip system of claim 13, wherein the replaceable tip system further comprises a coupler, wherein said coupler comprises:
a first connecting element disposed at said interior surface of said channel; and
a second connecting element disposed at said second outer surface of said shaft, wherein said second connecting element is configured to engage with said first connecting element in a form fit to supplement the frictional engagement and further secure said cutting element against removal from between said adapter and said wedge.

15. The replaceable tip system of claim 14, wherein:
said second connecting element comprises a recess in said shaft and said first connecting element projects beyond said interior surface of said channel and into said recess;
said first connecting element comprises an elongated element removably disposed in said adapter transverse to said channel and configured to engage said recess to further prevent axial movement of said shaft out of said channel;
and
said elongated element comprises a pin.

16. The replaceable tip system of claim 15, wherein:
said wedge comprises a side surface transverse to said contact surface;
said wedge comprises a slot disposed in said side surface;
said adapter comprises a projection projecting inwardly into said channel, wherein said projection is removably insertable into said slot to guide and further hold said wedge and said adapter together and thereby further enhance the frictional engagement between said shaft and said adapter;
said wedge comprises a pair of said side surfaces and a pair of said slots, one in each of said side surfaces; and
said adapter comprises a pair of said projections disposed on opposite sides of said channel and facing one another.

17. The replaceable tip system of claim 16, wherein:
said tip comprises a first end face disposed about said shaft;
said adapter comprises a second end face disposed about an end of said channel;
said first end face abuts said second end face when said shaft is inserted into said adapter; and
said adapter comprises a receptacle configured to receive a connecting structure to further detachably connect said adapter to said base and further bias said adapter toward said wedge to enhance the frictional engagement between said adapter and said shaft.
